(19) United States
(12) Patent Application Publication
(10) Pub. No.: US 2006/0236823 A1
(43) Pub. Date: Oct. 26, 2006

(54) Linesman pliers

(76) Inventor: Douglas A. MacLain, Plymouth, IN (US)

Correspondence Address: Barnes & Thornburg LLP, 600 One Summit Square, Fort Wayne, IN, 46802, US

(21) Appl. No.: 11/407,172

(22) Filed: Apr. 19, 2006

Related U.S. Application Data
(60) Provisional application No. 60/674,184, filed on Apr. 22, 2005.

(51) Int. Cl. B25B 7/02; B25B 13/00

(52) U.S. Cl. 81/418; 81/426.5; 81/124.4

(57) ABSTRACT

A linesman pliers is provided. The pliers have first and second pliers members forming first handle and jaw sections, respectively thereon. The first handle section may include a first wrench tool. The first jaw section includes a first wrench portion. The second handle section includes a second wrench tool. The second jaw section may include a second wrench portion. The first and second pliers members are pivotably attached to each other at a location between the first/second handle and the first/second jaw sections. And the first and second wrench portions of the first and second jaw sections, respectively, form a third wrench tool.

### RELATED APPLICATIONS

The present application is related to and claims priority to U.S. Provisional Patent Application, Ser. No. 60/674,184, filed on Apr. 22, 2005, entitled Linesman Pliers. The subject matter disclosed in that provisional application is hereby expressly incorporated into the present application.

### TECHNICAL FIELD

The present disclosure relates to tools useful for workmen in the electricity transmission industry, and more particularly this disclosure relates to multi-functional pliers useful to linesmen for replacing blown fuses.

### BACKGROUND AND SUMMARY

In the electrical current transmission industry it is necessary for technicians, referred to as linesmen, to climb poles (or be lifted via a bucket truck) to install, repair, and test equipment. Inherent in working at such heights, linesmen carry all the tools believed to be necessary to accomplish the required tasks. It is impractical to continually climb and descend a pole every time a new tool or piece of equipment is needed. One of the several tasks a linesman may perform while on the pole is fuse replacement. High voltage electrical systems typically implement open cutout devices in the circuits. These cutout devices are used in a primary circuit where opening the circuit is necessary under voltage or no load current. These cutout devices include the fuses which conduct current flowing through a particular circuit. Each fuse contains a fuse member, which is designed to break the circuit upon current overload. The fuse members burn through during such overloads. Consequently, the burned-out or “blown” fuses need replaced so the cutout device can be reused to complete the current. A conventional cutout device uses locking nuts or bolts to secure the fuse member thereto. Typically, these locking bolts and nuts come in one of three sizes. The bolts are typically ⅞ inch or 13/16 inch in dimension, and the nut is typically 9/16 inch in dimension. These bolts/nuts need to be loosened to remove an expired fuse member and then retightened to hold the new fuse member. Often the linesman will not know which wrench or wrenches will be necessary until the cutout is inspected. This requires the linesman to carry a complement of pliers and wrenches useful for replacing the fuses and accommodating the variety of bolt/nut sizes that might be encountered.

It would, therefore, be beneficial to provide a single tool that can be used to replace such a fuse which takes into account the possibility that multiple bolt/nut sizes or configurations could be encountered.

Accordingly, an illustrative embodiment of the present disclosure provides a linesman pliers which comprises first and second pliers members. The first pliers member includes first handle and jaw section. The first handle section includes a first wrench tool. The first jaw section includes a first wrench portion, a first cutting blade, and a first gripping surface. The second pliers member includes second handle and jaw sections. The second handle section includes a second wrench tool. The second jaw section includes a second wrench portion, a second cutting blade, and a second gripping surface. The first and second pliers members are pivotably attached to each other at a location between the first/second handle and the first/second jaw sections. At least a portion of the first and second jaw sections are pivotable toward and away from each other to open and closed positions by moving at least a portion of the first and second handle sections toward and away from each other. And the first and second wrench portions of the first and second jaw sections, respectively, form a third wrench tool.

In the above and other illustrative embodiments the linesman pliers may further comprise: the first and second cutting blades forming a cutting tool configured to cut an object when the first and second jaw members are moved to the closed position; the first and second gripping surfaces forming a gripping tool configured to hold an object when the first and second jaw members are directed to the closed position; a third wrench tool being a hex-wrench tool formed when the first and second jaw sections are closed; the third wrench tool being disposed at least partially through the first and second jaw sections; the first and second cutting tools are located in the first and second wrench portions, respectively; a pivot pin disposed through the first and second pliers members about which the first and second pliers members pivot; the third wrench tool being located between the first/second gripping surfaces and the pivot pin; the third wrench tool being located between the first/second gripping surfaces and the first/second cutting blades; the first wrench tool being located on the first handle section at a distal location from the pivot pin, and the second wrench tool being located on the second handle section at a distal location from the pivot pin; and the first, second and third wrench tools being each uniquely sized to accommodate fastener heads of at least three different sizes.

Another illustrative embodiment of the present disclosure provides linesman pliers which also comprises first and second pliers members. The first pliers member includes first handle and jaw section. The first handle section includes a first wrench tool. The first jaw section includes a first wrench portion. Similarly, the second pliers member includes second handle and jaw sections. The second handle section includes a second wrench tool. The second jaw section includes a second wrench portion. The first and second pliers members are pivotably attached to each other at a location between the first/second handle and the first/second jaw sections. At least a portion of the first and second jaw sections are pivotable toward and away from each other to open and closed positions by moving at least a portion of the first and second handle sections toward and away from each other. And the first and second wrench portions of the first and second jaw sections, respectively, form a third wrench tool.

In the above and other illustrative embodiments the linesman pliers may further comprise: first and second cutting blades located on the first and second jaw sections, respectively, to form a cutting tool; first and second gripping surfaces located on the first and second jaw sections, respectively, to form a gripping tool; the third wrench tool being a hex-wrench tool formed when the first and second jaw sections are closed; the hex-wrench tool being formed by the first wrench portion having first, second, third and fourth sides, and the second wrench portion having fifth, sixth, seventh and eighth sides, wherein the first and eighth sides form a first wrench side, and the fourth and fifth sides form a second wrench side when the first and second jaw sections are closed; and the first, second and third wrench tools each being uniquely sized to accommodate fastener heads of at least three different sizes.

Another illustrative embodiment of the present disclosure provides a linesman pliers which also comprises first and second pliers members. The first pliers member includes first handle and jaw sections. The first jaw section comprises a first hex-wrench portion. The second jaw section comprises a second hex-wrench portion. The first and second pliers members are pivotably attached to each other at a location between the first/second handle and the first/second jaw sections. At least a portion of the first and second jaw sections is pivotable toward and away from each other to open and closed positions by moving at least a portion of the first and second handle sections toward and away from each other. The first and second hex-wrench portions of the first and second jaw sections, respectively, form a hex-wrench tool.

In the above and other illustrative embodiments the linesman pliers may further comprise: the hex-wrench tool formed by the first hex-wrench portion having first, second, third and fourth sides, and the second hex-wrench portion having fifth, sixth, seventh and eighth sides, wherein the first and eighth sides form a first hex-wrench side, and the fourth and fifth sides form a second hex-wrench side when the first and second jaw sections are closed; and the hex-wrench tool formed by the first hex-wrench portion having first, second and third wrench sides, and the second hex-wrench portion having fourth, fifth and sixth wrench sides forming the hex-wrench when the first and second jaw sections are closed.

Additional features and advantages of the linesman pliers will become apparent to those skilled in the art upon consideration of the following detailed description of the illustrated embodiment exemplifying the best mode of carrying out the linesman pliers as presently perceived.

### BRIEF DESCRIPTION OF DRAWINGS

The present disclosure will be described hereafter with reference to the attached drawings which are given as non-limiting examples only, in which:

FIG. 1 is a side perspective view of an illustrative embodiment of a linesman pliers;

FIG. 2 is a side perspective view showing the opposite side of the linesman pliers of FIG. 1;

FIG. 3 is a forward perspective detail view of a portion of the linesman pliers of FIGS. 1 and 2;

FIG. 4 is a side perspective view of another illustrative embodiment of a linesman pliers;

FIG. 5 is a side perspective view showing the opposite side of the linesman pliers of FIG. 4;

FIG. 6 is a forward perspective detail view of a portion of the linesman pliers of FIGS. 4 and 5;

FIGS. 7 through 16 are demonstrative perspective views of an illustrative process of replacing a fuse employing an illustrative embodiment of a linesmen pliers; and

FIGS. 17(a) through (e) demonstrate functions that can be accomplished by the use of a single linesman pliers.

Corresponding reference characters indicate corresponding parts throughout the several views. The exemplification set out herein illustrates embodiments of the linesman pliers and such exemplification is not to be construed as limiting the scope of the linesman pliers in any manner.

### DETAILED DESCRIPTION OF THE DRAWINGS

An illustrative embodiment of the linesman pliers comprises a plurality of wrenches so the linesman can loosen or tighten any variety of nuts or bolts with a single tool. Such pliers comprise a pair of handles and jaw members attached via a pivot point or pin positioned there between. In one embodiment, each pliers handle includes a wrench formed thereon. Additionally, at least one wrench or portion of a wrench can be formed in the jaw members. In one embodiment, each jaw member may include a portion of the wrench that becomes formed when the jaw members are located in substantially their closed position. It is appreciated that each of the wrenches in the pliers can accommodate a different size bolt or nut. Such sizes illustratively include ⅞ inch, 9/16 inch, and 13/16 inch. It is further appreciated, however, that the wrenches can be configured to accommodate bolts or nuts of other dimensions and configurations as well. In another illustrative embodiment, just one wrench tool, such as a hex-wrench, can be formed in the jaw members.

In an additional embodiment, the three wrenches are accompanied by a vise or gripping surface on the jaw members to form a gripping tool. Also, opposing cutting blades on each jaw member forms a cutting tool. One embodiment comprises a single pliers tool that includes three wrenches adapted to engage various sizes of nuts or bolts, a gripping tool, and a cutting tool. Another embodiment includes a wrench formed in the jaw members.

The pliers tool can be useful to a linesman for changing out a fuse. This is particularly useful, since the cutout is typically located high off the ground and the linesman does not know the size of the nuts or bolts used to hold the fuse. In addition, the gripping and cutting surfaces can be used to assist installing the fuse. The gripping tool portion of the pliers can be used to grip objects between the vise surfaces when the handles are being closed. The cutting tool can be used to cut the excess fuse from the cutout, as well as other similar type tasks. This allows a single tool to be used to change the fuse, thereby reducing the number of tools the linesman needs to carry up the pole, as well as deploy while on the pole.

Under typical circumstances, the fuse is located in the cutout which is located on a power line pole or tower. If the fuse has blown, the linesman will replace it. Typically the cutout includes an elongated fuse tube enclosed at one end by a cap. Once the cap is removed, the blown fuse is removed and replaced. A typical fuse includes a base attached to a longitudinally-extending wire tail extending therefrom. Typically, such wire tails are made from aluminum strands. Tension is applied to the wire and held onto the cutout by a locking bolt/nut. Upon overload, the tail is severed from the fuse member and needs to be replaced. The pliers can then be used to loosen the locking bolts/nuts with an appropriate set of wrenches and pliers. Once the locking bolts/nuts are loosened, the used wire tail is removed.

Illustratively, to replace the fuse the wire tail is disposed through one end of the fuse tube of the cutout and exits the opposite end. The fuse has a fuse base that engages the periphery of the fuse tube opening to prevent the fuse from being completely pulled through the tube. The wire tail can then be pulled tightly about a groove formed on a tensioned bracket located exterior of the fuse tube. The tightly pulled wire tail is then wrapped around a threaded fastener on the bracket. The bolt head or nut is then tightened using a wrench, securing the wire tail between the bolt head/nut and the bracket. A biasing member acting on the bracket is configured to force the cutout device open when the fuse member has blown. Under normal operating conditions, the tension in the wire tail and fuse member keeps the cutout closed. Once the wire tail is secured, any excess wire tail can be cut using a cutting tool. Once this is done, the installation of the new fuse is essentially complete.

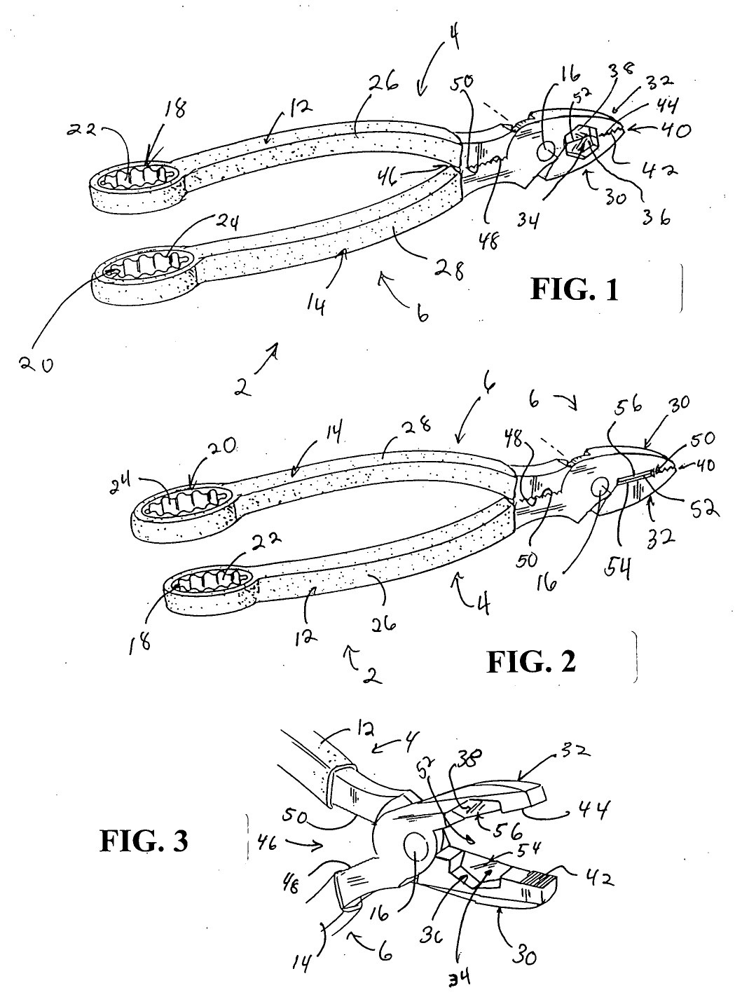

Side and forward perspective detail views of an illustrative embodiment of a linesman pliers 2 is shown in FIGS. 1-3. Particularly shown in FIG. 1, pliers 2 comprises plier members 4 and 6 with elongated handles 12 and 14, respectively. A pivot 16 moveably couples handles 12 and 14 together. Wrench heads 18 and 20 are attached adjacent handles 12 and 14, respectively, illustratively distal to pivot 16. Each of the wrench heads 18 and 20, illustratively comprises 12 point gripping surfaces 22 and 24, respectively. It is appreciated, however, that the wrenches can be of any desired configuration that will grip a bolt head, nut, or comparable-type fastening structure. In addition, it is contemplated that wrenches 18 and 20 are sized to receive bolt/nut heads of different sizes. For example, wrench 18 can be configured to receive a 9/16″ bolt head and wrench 20 can be configured to receive a 13/16″ or ⅞″ bolt head.

Illustratively, hand grip surfaces 26 and 28 are applied to handles 12 and 14 respectively. It is appreciated that the hand grip surfaces 26 and 28 can be made of suitable material including plastic, rubber, foam, and the like. Further shown in this illustrative embodiment is hand grip surfaces 26 and 28 extending about the periphery of wrenches 18 and 20. This may serve to assist in protecting against electrical shock. Opposite handles 12 and 14 on plier members 4 and 6, respectively, are jaw members 30 and 32. As shown, jaw members 30 and 32 are positioned distal from wrenches 18 and 20 with pivot 16 located there between. This illustrative embodiment comprises a wrench 34 disposed in jaw members 30 and 32. It is appreciated that each jaw member 30 and 32 includes a portion 36 and 38 of wrench 34. In the illustrated embodiment, wrench 34 is a hex wrench with each jaw member 30 and 32 including two surfaces of the hex wrench and then part of the other two surfaces. When jaw members 30 and 32 are located in a closed position, as shown in FIGS. 1 and 2, a six-surfaced hex wrench is formed. Also shown in this view is gripping tool 40 that is comprised of vise surfaces 42 and 44 on jaw members 30 and 32, respectively. Also in an illustrative embodiment, a gripping tool 46, comprising vise surfaces 48 and 50, is formed adjacent handles 12 and 14 and on the opposite side of pivot 16 with respect to gripping tool 40. It is appreciated, however, that both gripping tools 40 and 46 are not necessarily required in every embodiment. It is further appreciated that the vise surfaces shown having a serrated surface is illustrative as well. Other gripping surface configurations can be employed to satisfy the linesman utility.

The perspective view of FIG. 2 shows the opposite side of pliers 2. In this view, a cutting tool 52 is shown in jaw members 30 and 32 formed by cutting blades 54 and 56. As shown in the detail view of FIG. 3, having jaw members 30 and 32 located in the open position, cutting blades 54 and 56 are formed in wrench portions 36 and 38 of wrench 34. This particular embodiment takes advantage of the material removed from the jaw members that forms wrench 34 to form cutting blades 54 and 56 at a location opposite handles 12 and 14 with pivot 16 located there between. This allows cutting tool 52 to operate similar to scissors or shears so objects can be cut between the blades as the handles are closed together. This view also shows the configuration of the wrench portions 36 and 38 and how a portion of two of the six sides are split between the two jaw members. It is appreciated that this particular configuration of wrench 34, including its hex shape and orientation of that shape, is illustrative and other wrench shapes could be used in its place in other embodiments.

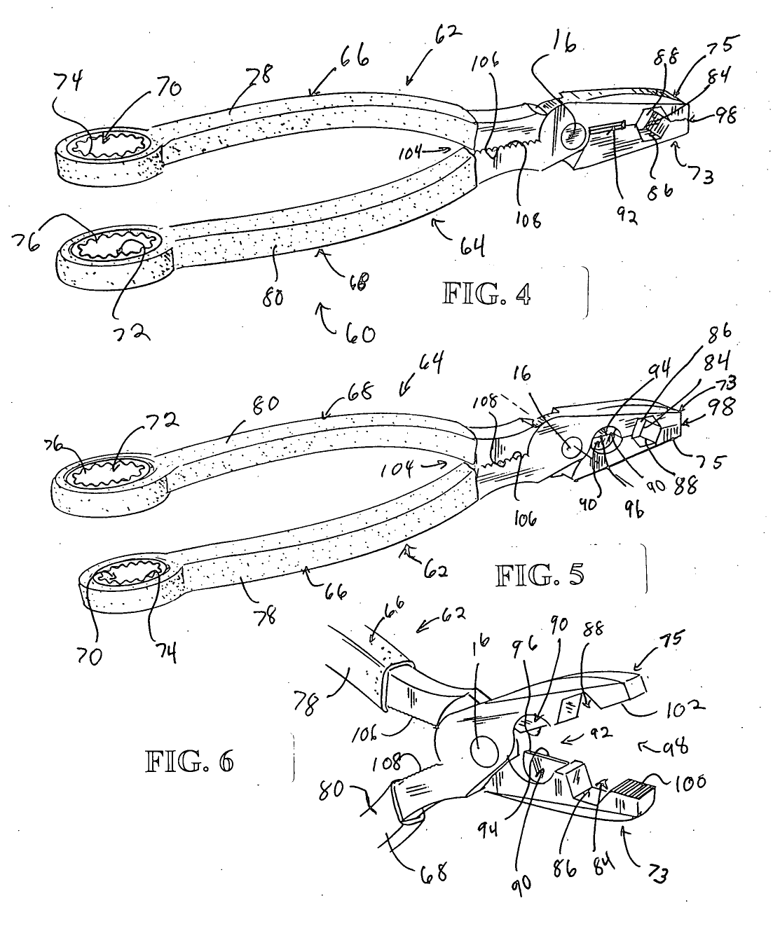

Another illustrative embodiment of a linesman pliers 60 is shown in FIGS. 4-6. This embodiment includes plier members 62 and 64. Similar to the previous embodiment, handles 66 and 68 are located opposite jaw members 73 and 75 with pivot 16 located there between. Wrenches 70 and 72 are illustratively located at distal ends of handles 66 and 68. Also similar to the previous embodiment, the wrenches illustratively include 12 point gripping surfaces 74 and 76, respectively. Also, gripping surfaces 78 and 80 are disposed on the handle and illustratively about the wrenches 70 and 72, respectively, similar to the previously illustrated embodiment.

Pliers members 62 and 64 include jaw members 73 and 75 located opposite handles 66 and 68 with pivot 16 there between, so the handles can be used to open and close the jaw members similar to the previous embodiment. In this present embodiment, however, the configuration of jaw members 73 and 75 are different. For example, the additional wrench 84, which is composed of wrench portions 86 and 88 formed in jaw members 73 and 75, respectively, is illustratively disposed all the way through the jaw members. In addition, though also being a hex-style wrench, each wrench portion 84 and 86 includes three complete sides that form the hex wrench when jaw members 73 and 75 are moved to the closed position, as shown in FIGS. 4 and 5. This configuration may be desirable in certain circumstances where the fastener head is longer than the thickness of the jaw members.

To accommodate a cutting tool 92 in this embodiment, a separate cavity 90 is formed in jaw members 73 and 75. As shown in FIG. 5, a cutting tool 92 is formed by opposed cutting blades 94 and 96. Cutting tool 92 is located between wrench 84 and pivot 16. The detail perspective view of FIG. 6 showing jaw members 73 and 75 in the open position, further illustrates this configuration of cutting tool 92 with respect to wrench portions 86 and 88. This embodiment also shows gripping tool 98 comprising of vise surfaces 100 and 102 which operates similar to that previously described with respect to gripping tool 40. Also similar to the previous embodiment is optional gripping tool 104 comprising gripping surfaces 106 and 108 which opens and closes as pliers members 62 and 64 pivot about pivot 16.

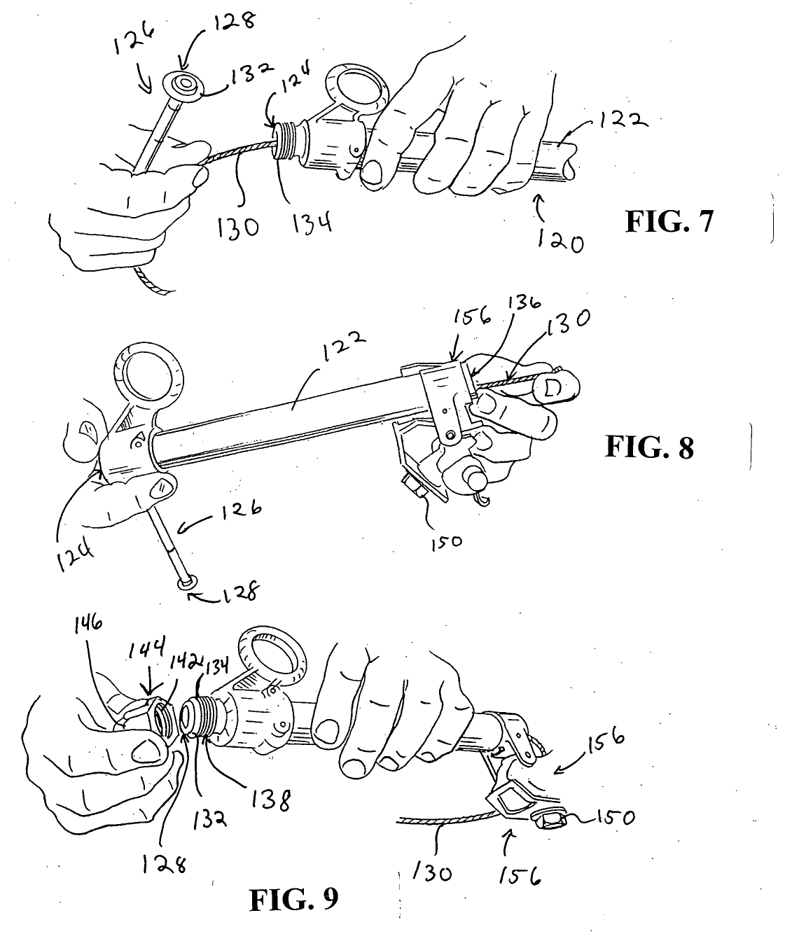

Demonstrative views disclosing an illustrative process for replacing a cutout fuse is shown in FIGS. 7-16. It is contemplated that this process is illustrative and variations can exist that still require the utility of the linesman pliers. In one embodiment of this process, a single tool is used to assist changing the cutout fuse. An open cutout device 120 used in high voltage line work is shown in FIG. 7. The cutout device 120 includes a longitudinally-extending fuse tube 122 terminating at an opening 124 located at the end thereof. A fuse 126 comprising a base member 128 and wire tail 130 is shown as well. To install fuse 126 to cutout device 120, wire tail 130 is first disposed through opening 124 and extends through tube 122. Wire tail 130 extends through tube 122 until a flange portion 132 or base member 128 engages the outer periphery 134 of tube 122 at opening 124, as illustratively shown in FIGS. 8 and 9. As particularly shown in FIG. 8, wire tail 130 is drawn through tube 122, exiting out a second end 136, illustratively axially opposed to opening 124. As shown in FIG. 9, flange 132 caps outer periphery 134 of opening 124. Adjacent that outer periphery are threads 138 configured to receive corresponding internal threads 142 of cap 144. This secures fuse 126 into cutout 120, as well as generally centering the wire tail 130 within tube 122.

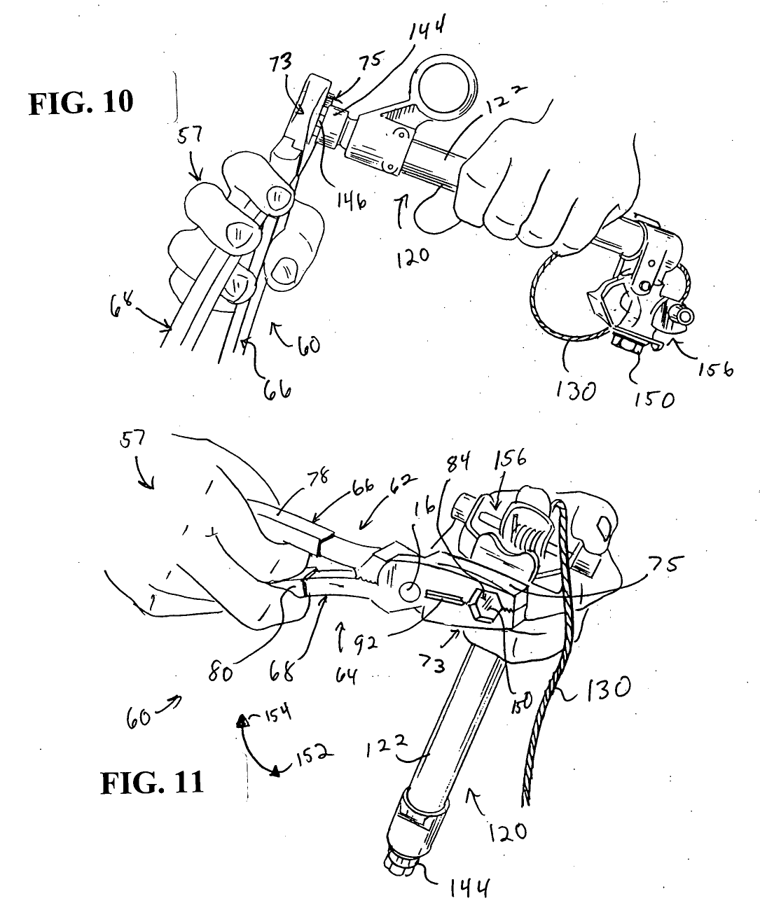

Once cap 144 engages threads 138, jaw members 73 and 75 can be closed onto end cap 144 to tighten the same. In one embodiment, depending on the size of bolt head 146 on cap 144, hex wrench 84 formed in jaw members 73 and 75 can engage and tighten the same, as shown in FIG. 10.

The view in FIG. 11 shows wrench 84 engaging bolt 150 fastened to cutout 120. In this illustrative embodiment, jaw members 73 and 75 of pliers 60 are maintained in the closed position by the linesman's grip 57 on handles 66 and 68. The wrench portions 86 and 88 are closed or partially closed to form wrench 84, which is sized to receive bolt head 150. (See also, FIGS. 4-6). It is appreciated, as well as a common practice, that bolt 150 will be of any variety of sizes. In one particular instance, bolt 150 can be a 13/16 inch bolt. As linesman 57 rotates handles in either directions 152 or 154, bolt head 150 will tighten or loosen as desired. Typically, the linesman will have to loosen the bolt first to remove any portion of the blown fuse that may still be attached before installing a new fuse. Wire tail 130 then engages a tensioned bracket assembly 156.

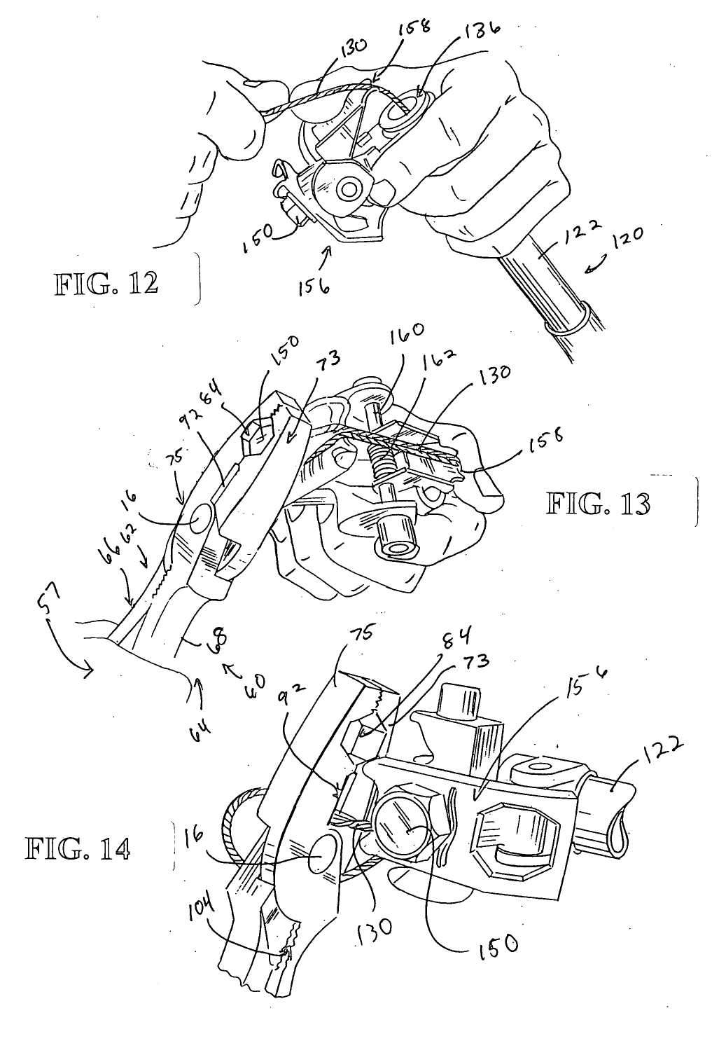

The demonstrative view of FIG. 12 shows wire tail 130 extending from second end 136. Illustratively, wire tail 130 is tensioned by hand and wrapped onto groove 158 of tensioned bracket 156. Wire tail 130 is then wrapped around bolt 150 and pulled tight. Wrench 84 and jaw members 73 and 75 are used to engage bolt 150 to tighten the same, as shown in FIG. 13. This ensures the wire tail is pulled and held taut through tube 122. It is appreciated, however, that bolt 150 can and is often a different size than cap 144. Without wrench 60, the linesman must have a pair of conventional pliers in addition to a compliment of different wrenches, since the actual size of the bolt heads cannot be anticipated. It is contemplated that this single tool can accommodate the common varieties of bolt sizes used in such cutout devices. Typically, such bolt sizes can be 9/16 inch, ⅞ inch, and 13/16 inch. During operation, wire tail 130 is illustratively secured to bracket 156, so enough tension exists to pull fuse tube 122 towards bracket 156 about pin 160. Spring 162 biases fuse tube 122 away from bracket 156, but is held in place due to fuse 126 being secured within tube 122. Typically, when cutout 120 is energized, fuse 126 along with wire tail 130 conduct the current flowing through the connected circuit. When fuse 126 conducts more current than it can sustain, base 128 burns through (or blows) disconnecting it from wire tail 130. This disconnection allows spring 162 to pull or bias fuse 126 away from bracket 48 opening the circuit associated with cutout 120. At this point fuse 126 needs to be replaced again.

As shown in FIGS. 13 and 14, the same tool used to tighten bolt 150 can also be used to trim any excess wire tail 130 from the cutout. In this case, cutting tool 92 formed via blades 94 and 96 in jaw members 73 and 75, respectively, can be used. In this illustrative embodiment, pliers 60 has the added utility of allowing tightening of bolt 150 and trimming wire 130 without the linesman's grip 57 having to be released from handles 66 and 68. This saves the linesman from having to switch out tools, and allows the linesman to maintain the same grip on the same tool to perform both operations.

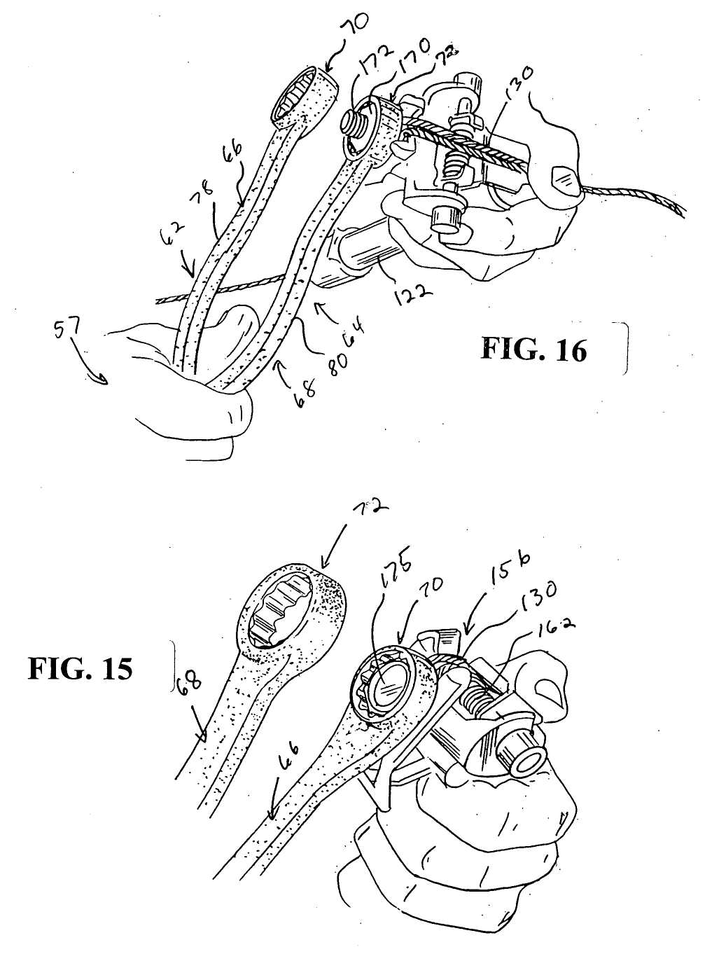

In certain cases, the fastener used to hold wire tail 130 can be of alternate configuration. As shown in FIG. 16, a nut 170 is disposed on a threaded bolt 172 extending from bracket 156. It is appreciated that nut 170 may be a ⅞ inch nut not compatible with a 9/16 inch wrench. Having wrench 72 available on the end of handle 68 to grip nut 170 for either tightening or loosening the same provides flexibility by accommodating a variety of fastener sizes without having to exchange tools. Similarly, as shown in FIG. 15, the fastener used to hold wire tail 130 on bracket 156 might be a 9/16 inch bolt 175; again, not necessarily compatible with wrench sizes previously discussed. Having an additional wrench 70 disposed from handle 66 can be useful in such circumstances. Again, this allows the linesman to use a single tool with a plurality of wrenches formed thereon to accommodate any of the various bolt configurations employed on typical cutout devices.

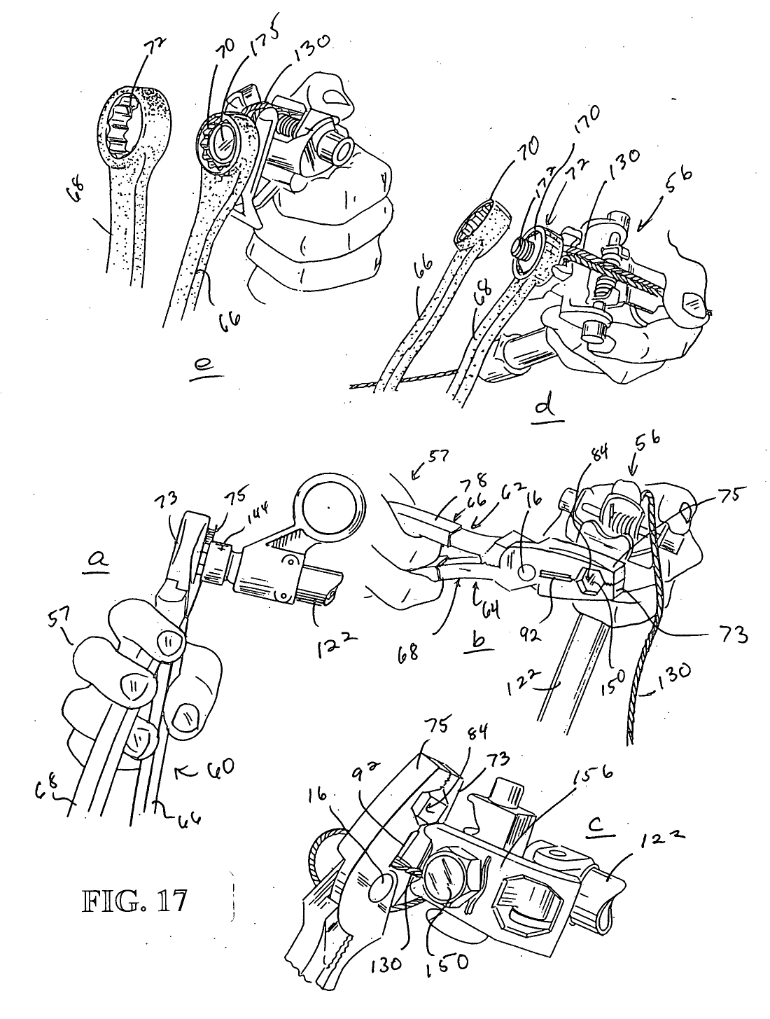

The several views of FIGS. 17a-e demonstrate the several functions linesman pliers 60 or pliers 2 can accomplish. While using the same grip on the handles, the linesman pliers can loosen or tighten caps or bolts using the gripper and/or wrench in the jaw members and cut excess wire tail from the fuse, as shown in FIGS. 17a-c. After scaling the pole and examining the cutout, if the linesman determines that the bracket fastener is a different size or configuration, the same tool has two additional wrenches of illustratively, two additional sizes to use on the alternate fastener configuration, as shown in FIGS. 17d-e. This single tool can, therefore, be used to switch out fuses on many typical cutout devices.

Although the present disclosure has been described with reference to particular means, materials, and embodiments, from the foregoing description, one skilled in the art can easily ascertain the essential characteristics of the present disclosure and various changes and modifications may be made to adapt the various uses and characteristics without departing from the spirit and scope of the present invention, as set forth in the following claims.

What is claimed is:

1. A linesman pliers comprising:
a first pliers member which comprises:
a first handle section which comprises a first wrench tool;
a first jaw section which comprises a first wrench portion, a first cutting blade, and a first gripping surface; and
a second pliers member which comprises:
a second handle section which comprises a second wrench tool; and
a second jaw section which comprises a second wrench portion, a second cutting blade, and a second gripping surface;
wherein the first and second pliers members are pivotably attached to each other at a location between the first/second handle and the first/second jaw sections;
wherein at least a portion of the first and second jaw sections are pivotable toward and away from each other to open and closed positions by moving at least a portion of the first and second handle sections toward and away from each other; and
wherein the first and second wrench portions of the first and second jaw sections, respectively, form a third wrench tool.

2. The linesman pliers of claim 1, wherein the first and second cutting blades form a cutting tool that is configured to cut an object when the first and second jaw members are moved to the closed position.

3. The linesman pliers of claim 1, wherein the first and second gripping surfaces form a gripping tool that is configured to hold an object when the first and second jaw members are directed to the closed position.

4. The linesman pliers of claim 1, wherein the third wrench tool is a hex-wrench tool formed when the first and second jaw sections are closed.

5. The linesman pliers of claim 1, wherein the third wrench tool is disposed at least partially through the first and second jaw sections.

6. The linesman pliers of claim 1, wherein the first and second cutting tools are located in the first and second wrench portions, respectively.

7. The linesman pliers of claim 1, further comprising a pivot pin disposed through the first and second pliers members about which the first and second pliers members pivot.

8. The linesman pliers of claim 7, wherein the third wrench tool is located between first/second gripping surfaces and the pivot pin.

9. The linesman pliers of claim 7, wherein the third wrench tool is located between first/second gripping surfaces and first/second cutting blades.

10. The linesman pliers of claim 7, wherein the first wrench tool is located on the first handle section at a distal location from the pivot pin, and the second wrench tool is located on the second handle section at a distal location from the pivot pin.

11. The linesman pliers of claim 1, wherein the first, second, and third wrench tools are each uniquely sized to accommodate fastener heads of at least three different sizes.

12. A linesman pliers comprising:
a first pliers member which comprises:
a first handle section which comprises a first wrench tool; and
a first jaw section which comprises a first wrench portion; and
a second pliers member which comprises:
a second handle section which comprises a second wrench tool; and
a second jaw section which comprises a second wrench portion;
wherein the first and second pliers members are pivotably attached to each other at a location between the first/second handle and the first/second jaw sections;
wherein at least a portion of the first and second jaw sections are pivotable toward and away from each other to open and closed positions by moving at least a portion of the first and second handle sections toward and away from each other; and
wherein the first and second wrench portions of the first and second jaw sections, respectively, form a third wrench tool.

13. The linesman pliers of claim 12, further comprising first and second cutting blades located on the first and second jaw sections, respectively, to form a cutting tool.

14. The linesman pliers of claim 12, further comprising first and second gripping surfaces located on the first and second jaw sections, respectively, to form a gripping tool.

15. The linesman pliers of claim 12, wherein the third wrench tool is a hex-wrench tool formed when the first and second jaw sections are closed.

16. The linesman pliers of claim 15, wherein the hex-wrench tool is formed by the first wrench portion having first, second, third and fourth sides, and the second wrench portion having fifth, sixth, seventh and eighth sides, wherein the first and eighth sides form a first wrench side, and the fourth and fifth sides form a second wrench side when the first and second jaw sections are closed.

17. The linesman pliers of claim 12, wherein the first, second, and third wrench tools are uniquely sized to accommodate fastener heads of at least three different sizes.

18. A linesman pliers comprising:
a first pliers member which comprises:
a first handle section; and
a first jaw section which comprises a first hex-wrench portion; and
a second pliers member which comprises:
a second handle section; and
a second jaw section which comprises a second hex-wrench portion;
wherein the first and second pliers members are pivotably attached to each other at a location between the first/second handle and the first/second jaw sections;
wherein at least a portion of the first and second jaw sections are pivotable toward and away from each other to open and closed positions by moving at least a portion of the first and second handle sections toward and away from each other; and
wherein the first and second hex-wrench portions of the first and second jaw sections, respectively, form a hex-wrench tool.

19. The linesman pliers of claim 18, wherein the hex-wrench tool is formed by the first hex-wrench portion having first, second, third, and fourth sides, and the second hex-wrench portion having fifth, sixth, seventh, and eighth sides, wherein the first and eighth sides form a first hex-wrench side, and the fourth and fifth sides form a second hex-wrench side when the first and second jaw sections are closed.

20. The linesman pliers of claim 18, wherein the hex-wrench tool is formed by the first hex-wrench portion having first, second, and third wrench sides, and the second hex-wrench portion having fourth, fifth, and sixth wrench sides forming the hex-wrench when the first and second jaw sections are closed.
